(19) United States
(12) Patent Application Publication
(10) Pub. No.: US 2020/0257736 A1
(43) Pub. Date: Aug. 13, 2020

(54) Hybrid Datacenter for Dynamic Delta Documentation

(71) Applicant: Dell Products L.P., Round Rock, TX (US)

(72) Inventors: Mainak Roy, Kolkata (IN); Chitrak Gupta, Bangalore (IN); Rathi Babu, Bangalore (IN); Swapna M, Bangalore (IN); Abhirup Seal, Kolkata (IN)

(73) Assignee: Dell Products L.P., Round Rock, TX (US)

(21) Appl. No.: 16/274,692

(22) Filed: Feb. 13, 2019

(51) Int. Cl. G06F 16/93; G06F 16/9032; G06F 16/9035; G06Q 30/06

(52) U.S. Cl. CPC G06F 16/93; G06Q 30/0631; G06F 16/9035; G06F 16/9032

(57) ABSTRACT

A system, method, and computer-readable medium for improved document management for products and/or services. A hybrid datacenter is implemented to manage various documents and files for multiple products/services that are provided by different companies/vendors/suppliers. User intent search is performed on a product and documents related to the product are searched for. Current and previous release versions of the documents are compared, and a delta document is created. The delta document shows relevant changes and provides recommendation as to use and implementation of updates, upgrades and changes to the product.

### BACKGROUND OF THE INVENTION

### Field of the Invention

The present invention relates to the management of information handling systems. More specifically, embodiments of the invention provide a system, method, and computer-readable medium for improved document management for products and/or services.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Users, such as customers for products and/or services, desire knowledge and not merely information about such products and/or services. Such knowledge should be specific and complete to the user's needs. Knowledge, in comparison to mere information, provides an ability to understand a subject (e.g., product and/or subject). For example, knowledge can assist a user to use, upgrade, and troubleshoot a particular product. When a user performs a search on a particular product or service for applicable documents (e.g., document sets, html pages, pdf or doc files etc.), a web search engine will typically provide a list of documents based on a search query, where the list is ranked based on a matched key word(s) and information with source content that matches the search query. If the search query is generic, then the search results can also be generic. In many cases, a user may not have the ability/experience to perform a more specific search, and is provided generic search results.

In certain cases, a user implements a product or products that is/are associated with other products. A datacenter may support/require documents related to the particular product and associated products. When a product that is associated with other products is changed (e.g., upgraded, updated), the impact of the change should be understood for documents supporting the datacenter. For example, a datacenter may include documentation related to a number of server computers. If a new operating system is deployed for these server computers, the impact can be different for each of the server computers. It would be desirable to determine issues such as whether the new operating system is compatible with the server computers. As for users of server computers, there is desire to know which documents are applicable for their particular server computer and implementation.

For datacenter administrators that support multiple products, there is a desire to identify compatibility information between products whenever upgrades, updates or changes are made. This can include updating and providing information to users/customers as to the effects of such upgrades, updates, and changes, and understand new or different features related to the products.

There may be certain technologies that provide product configuration solutions based on specific requirements; however, when upgrades or changes are made to documentation related to a user or customer's specific product or products, the user needs to understand how upgrades or changes impact their product or products. Certain technologies may provide for purchase and support of products; however, there is a need to provide accurate tools to address different products from different companies based on particular configurations and parameter mappings. Technologies may provide planning and recommendation as to infrastructures; however, there is a need to provide information as to compatibility with other products and to suggest particular upgrades and features without impacting any existing functions.

In certain cases, a search is performed based on a product search query. The need though may be directed to a support feature, such as an application programming interface (API) that is related to the product. For example, if a search is performed for a particular computer processor, the search query is performed based on the name of the computer processor. The need is related to an API and documents related to the processor.

### SUMMARY OF THE INVENTION

A system, method, and computer-readable medium are disclosed for improved document management for products and/or services. In various embodiments, a hybrid datacenter is implemented to manage various documents and files for multiple products/services that are provided by different companies/vendors/suppliers.

In various embodiments, a user performs a search for a product, documents related to the product are determined and searched for. The searching can be performed on internal and external resources, such as databases and web environments. Current and previous versions of the documents are compared, and a determination is made as to relevant changes, including minor changes that can impact product use or implementation. The relevant changes are provided in a delta document which can include recommendations to the user. In certain implementations searching can be performed as to features of the product, and to documents related to such features.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system as implemented in the system and method of the present invention;

FIG. 2 is a simplified block diagram of a hybrid datacenter;

FIG. 3 is a generalized flowchart for creating delta documents in accordance with an embodiment of the invention;

FIG. 4 is a simplified block diagram of a hybrid data center for document management for products and/or services

FIG. 5 is a generalized flowchart for document management for products and/or services.

### DETAILED DESCRIPTION

A system, method, and computer-readable medium are disclosed for improved document management for products and/or services. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

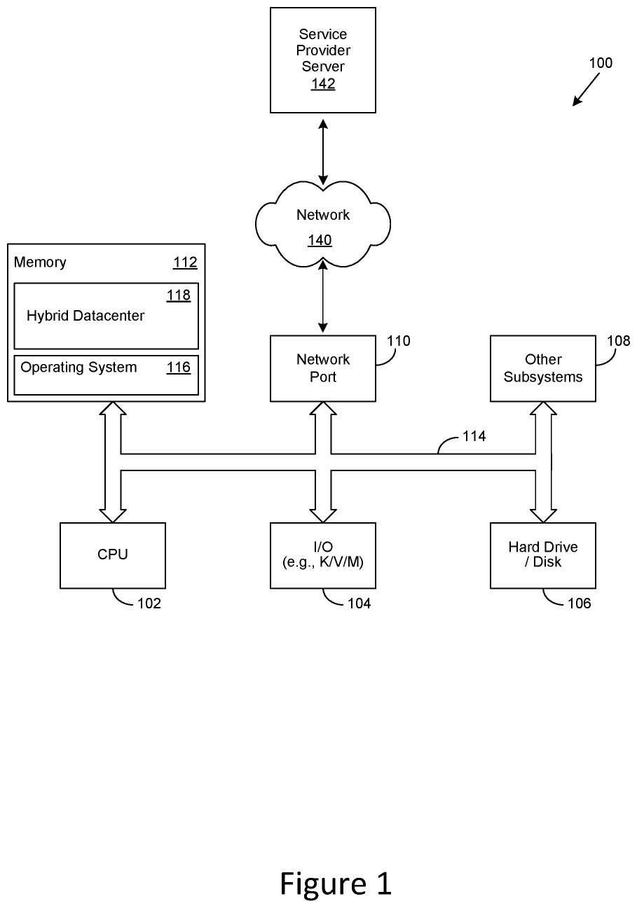

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise a hybrid datacenter 118. In certain embodiments, the hybrid data center is configured to support multiple products and/or services that are provided by different companies, vendors, suppliers, etc. In certain implementations, the hybrid datacenter 118 is provided as a service from the service provider server 142.

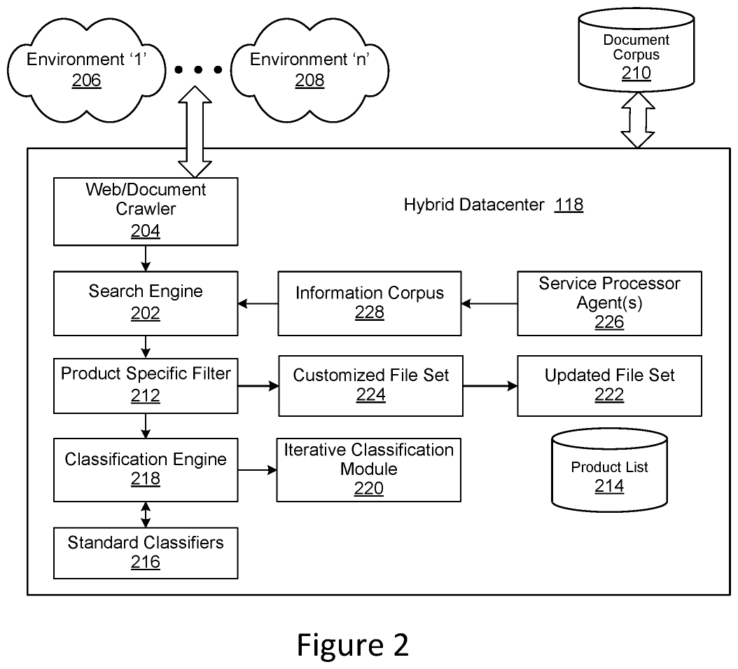

FIG. 2 is a simplified block diagram of a hybrid datacenter. In certain embodiments, the hybrid datacenter 118 is configured to support multiple products and/or services that are provided by different companies, vendors, suppliers, etc. In general, the hybrid datacenter 118 provides for document management of products and/or services, including services related to particular products. In particular, hybrid datacenter 118 is configured to provide specific documents relevant to users' products. Documents can include videos and learning modules, release notes, installation guides, users' guides, multiple documents for the product, etc. Furthermore, documents can refer to files, data, or other information related to products.

In certain embodiments, the hybrid datacenter 118 includes a web engine 202. For example, users can perform search queries directed to a particular product(s) through search engine 202. The hybrid datacenter 118 can allow users to perform intent specific results based on users' search queries. In certain implementations, users are provided classified results based on the intent of their searches. Intent can be based on search query parameters. Classification of the documents can be based on the users' intent. In certain implementations, hybrid datacenter 118 is configured to perform internal recursive classification based on product documentation and binding. For example, if a search query is performed on the word “server,” general or generic results are returned. The search results can be refined through specific filters.

By using intent based classification, the search can be classified for example under the following categories a) purchase, b) support, c) additional hardware, d) reviews. This can be a first level of classification based on user intent. By selecting a title, a user can select a classifier that creates/provides the documents and a next level of classification details. For example, the user may select a) purchase. The title a) purchase can return links to particular servers: i) server 123, ii) server 456, iii) server 789, or iv) other servers.

In certain implementations, the hybrid datacenter 118 includes a web/document crawler 204. The web/document crawler 204 can be configured to copy web pages (i.e., documents) for processing by search engine 202. In certain embodiments, documents related to product or services are available on different sites, platforms, or environments. These sites, platforms, or environments can include vendor support sites, social media sites, data repositories, etc. Such sites, platforms, or environments are represented as environment ‘1’ 206 through environment ‘n’ 208. The web/document crawler 204 can be configured to crawl or search for documents that are available on environment ‘1’ 206 through environment ‘n’ 208. In particular, data that are not specific to a business that are provided by outside companies, vendors or suppliers, can be searched and fetched through web/document crawler 204.

In addition to environment ‘1’ 206 through environment ‘n’ 208, other sources of documents. For example, a document corpus 210 can be source of documents. From all the sources, unclassified documents are available. The hybrid datacenter 118 classifies the documents and provides structured information to users. Classification and representation of documents is product specific. A product specific filter 212 can be implemented to identify documents based on particular products. Products that are supported or recognized by hybrid datacenter 118 can be stored in a database, product list 214. In certain implementations product list 214 is control by an administrator of hybrid datacenter 118. Values for product list 214 can change as products are added, removed or changed in hybrid datacenter 118.

In certain embodiments, a set of classifiers or standard classifiers 216 can be implemented. The standard classifiers 216 can be a standard text classifier, such as a natural language toolkit text classifier. As discussed above, classified documents can show a first level of classification and information with the first level of classification. In certain implementations, the hybrid datacenter 118 includes a classification engine 218. The classification engine 218 can cache documents related to subcategories of the first level classified documents. In certain implementations, the classification engine 218 can provide instruct an iterative classification module 220 to cache data, such as information to subcategories that are identified by the classification engine 218. For example, when a user action is detected, a document is presented by such user action. In turn, the document can initiate through the classification engine 218, other documents. Documents that are classified can be cached. In an example scenario, through a user action that is detected, “purchase” is a first level classifier. Documents that are related to the “purchase” and other classified data (i.e., information), such as “warranties” or “returns” are provided. The following is an example of classification of data representation.

Laptops

Purchase

Company A

Screen Size
CPU Power
RAM Size
...

Company B

Screen Size
CPU Power
RAM Size
...

Service
Reviews

In certain cases, a user implements certain products in a particular infrastructure. Changes, including updates, can at times be available for the products. Users should be able to understand how such changes impact or affect their products and the infrastructure in which the products are implemented. Documents that provide such information can be provided by the hybrid datacenter 118. Such documents related to the changes in the product can be referred to as delta documentation.

For example, hybrid datacenter 118 includes delta documentation that relates to several server computers from different companies. The deployment of a new operating system affects each of the server computers differently. The hybrid datacenter 118 can provide the delta documentation related to each server computer informing the compatibility of the upgraded operating system with the server computers of the user.

In certain embodiments, the document corpus 210 includes the delta documents. In certain implementations, a support site provides the delta documents to users. The delta documents enable users to determine the differences and what is new in release, such as an operating system change release. Furthermore, the delta documents can allow the comparison of existing and updated release versions, such as an operating system, and impact on products (e.g., server computers). The delta documents can assist users in knowing and understanding differences about products incorporating updated releases (e.g. operating system) and are part of users' infrastructure. In certain implementations, an updated file set 222 is provided to users. The updated file set 222 can include products specific to a business/company which is received from customized file set 224, and other products from different businesses/companies.

In certain embodiments, the document corpus 210 can be the basis to create the customized file set 224, and includes documents that are compared, where in the comparison is between previous and latest sets of documents. In certain implementations, an application programming interface or API, such as Redfish® API can be implemented to accesses document corpus 210. For other documents, such as documents related to products from other companies, web/document crawler 204 can be implemented to search and fetch documents from other sources or environment ‘1’ 206 through environment ‘n’ 208. Such documents can then be entered into document corpus 210. From the document corpus 210, a dynamic delta documentation operation can take place, where information is fetched as to what is new in a release by analyzing all the supported documents pertaining to that release and the previous release that is in use by users. After analyzing the differences, the operation segregates content between the previous and the latest releases and can generate delta documents for the users. The delta documents can include compatibility information between different products and provide suggestions as to upgrades. In addition to delta documentation, the operations of hybrid data center 118 can include taking into account localization and globalization when generating documents, such as the delta documents. Furthermore, search operations, can be performed for support features related to products, such as APIs.

In creating delta documents for a user, the hybrid datacenter 118 can look to the product list 214 for products, whether provided specific to the business/company or products from other businesses/companies. Such products can be identified in product list 214 by part numbers and by business/company. The hybrid datacenter 118 is configured to search for inventory related documents that are available to the hybrid datacenter 118. A first pass can be made with products that are specific to the business/company, where the document corpus 210 is searched. A customized file set 224 is created for the user based on the user's products. Information or data that is not available on document corpus 210, such as products provided by other businesses/companies are searched for by the web/document crawler 204. Related documents that are found are entered in the customized file set 224. An updated file set 222 is created with documents related to the business/company and other businesses/companies.

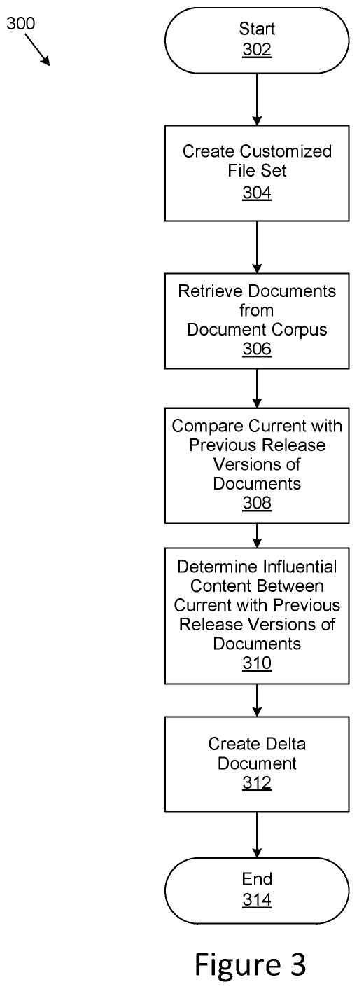

FIG. 3 is a generalized flowchart 300 for creating delta documents in accordance with an embodiment of the invention. In various embodiments, the hybrid datacenter 118 is implemented. The order in which the method is described is not intended to be construed as a limitation, and any number of the described method blocks may be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

Initialization starts at step 302. At step 304, a customized file set is created for a user. The customized file set is specific to products of the user. An initial customized file set can be directed to products specific to a business/company, and documents related to other businesses/companies can be subsequently searched and fetched. At step 306, documents are retrieved from a common storage location, such as a document corpus 210. The retrieved documents are defined by a set of dependent parameters. In particular, search parameters as discussed above. Documents related to a user's products can include videos and learning modules, release notes, installation guides, users' guides, multiple documents for the product, etc. At step 308, a comparison is performed between current and previous release versions of documents. The comparison is performed to determine any changes. At step 310, a determination is made if the changes include relevant or influential content between current and previous release versions. At step 312, a delta document(s) is/are created. A delta document can include compatibility information regarding different products (e.g., business/company and non-business/company products) and suggestions as to implementation and upgrading. The flowchart 300 ends at step 314.

In certain implementations, a compatibility matrix as to the user's products and/or infrastructure implementation is provided. Since a set of dependent search parameters is used, there can be greater accuracy and relevance in guiding users in implementing their products. Users are not only provided a solution configuration based on their specific requirements, the delta documents can allow users to know and understand the differences between products, latest/current releases and impact on users' infrastructure implementation. Users can be provided an online tool to purchase, report and support their products, and also be provided an accurate model to inform the users as to different products from different businesses/companies based on the critical mapping search parameters. In addition, an infrastructure planning tool can be provided to users. In addition, delta documents provide users comp compatibility level information among different products. A delta document can provide suggestions as to upgrading features, products, components, etc.

In certain instances, data or information related to features of a product are not easily identified to users through conventional search techniques. For example, an application programming interface or API can be specific to a user's product(s). Typically, documents related to an API are driven by API document related keywords, and not by product details or related technology. For example, if a server computer or processor of the server computer is searched for, documents that are returned may not be related to the API or related API documents.

Referring back to FIG. 2, service processor agent(s) 226 can be implemented. The service processor agent(s) 226 are implemented to parse request responses directed to particular APIs. Examples of APIs include WSMan API, DCIM_CPUView, Redfish URI for Processor, etc. Documentation for the particular APIs are returned to the user. In an implementation, the service processor agent(s) 226 are agents running on service processors or platforms, such as Dell® iDRAC and CMC. The APIs are treated as document names and response to the API search are treated as documents. In certain implementations, service processor agents provide API requests to an information corpus 228. The information corpus implements the search engine 202 to search for API related documents. The search engine 202 can be a standard indexing based search engine which implements industry standard indexing. The documents can retrieved or made available in document corpus and/or environment ‘1’ 206 through environment ‘n” 208. User search queries as to product names/related technology will retrieve related APIs and/or documentation related to APIs.

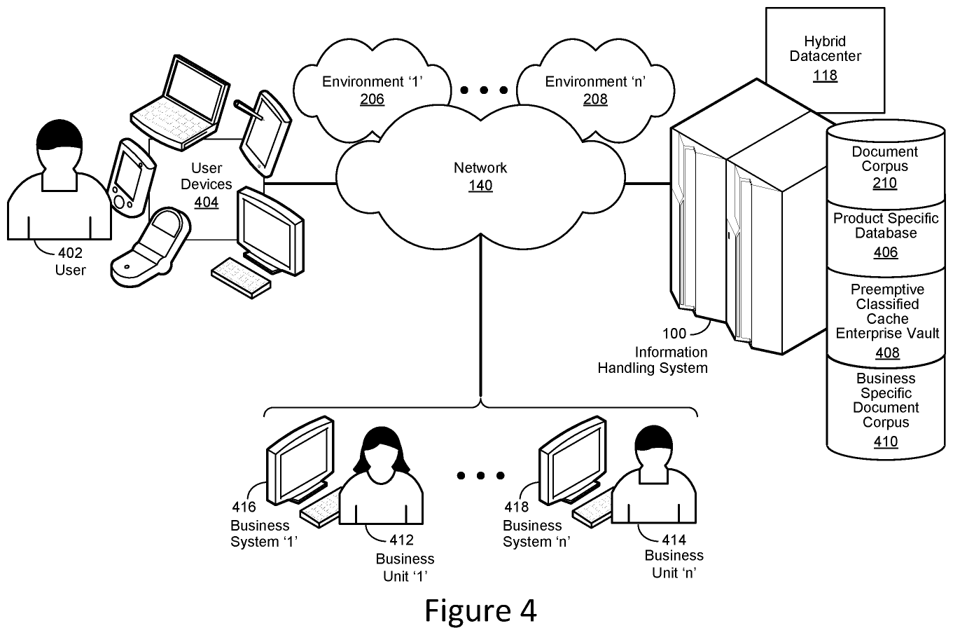

FIG. 4 is a simplified block diagram of a hybrid data center implemented in accordance with an embodiment of the invention for document management for products and/or services. In various embodiments, a user 402 can request for information, data, files, documents related to product(s) and/or infrastructure implementing the product(s) of user 402. User 402 can be representative of multiple users. Request from user 402 can be through a document or search query implemented by hybrid datacenter 118. In certain implementations, information, data, files, documents related to product(s) are proactively sent to user 402. For example, if user 402 has specific products, whenever revised or updated documents are available for the products, such documents are sent to the user 402.

In these and other embodiments, the user 402 may use a user device 404 to request information, data, files, documents related to product(s) and/or infrastructure from hybrid datacenter 118. An action by user 402 can be detected by the hybrid datacenter 118, where such action initiates a document which can be presented for classification. As used herein, user device 404 refers to an information handling system such as a personal computer, a laptop computer, a tablet computer, a personal digital assistant (PDA), a smart phone, a mobile telephone, or other device that is capable of communicating and processing data. In various embodiments, the user device 404 is used to exchange information between the information handling system 100 through the use of a network 140. In certain embodiments, the network 140 may be a public network, such as the Internet, a physical private network, a wireless network, a virtual private network (VPN), or any combination thereof. Skilled practitioners of the art will recognize that many such embodiments are possible, and the foregoing is not intended to limit the spirit, scope or intent of the invention.

In certain implementations, the information handling system includes the document corpus 210; a product specific database 406 that includes all products supported by hybrid datacenter 118; a preemptive classified cache (enterprise vault) 408 that can be used to cache classified documents; and a business specific document corpus 410 that stores document related to the particular business.

In certain implementations, business unit ‘1” 412 through business unit ‘n’ 414 interact with user 402. Business unit ‘1” 412 through business unit ‘n’ can be administrators of the hybrid datacenter 118. Business unit ‘1” 412 through business unit ‘n’ 414 may implement or administer the hybrid datacenter 118 to provide or update particular documents available to the user 402. Communication by business unit ‘1” 412 through business unit ‘n’ 414 can be through network 140 through respective business system ‘1’ 416 through business system ‘n’ 418.

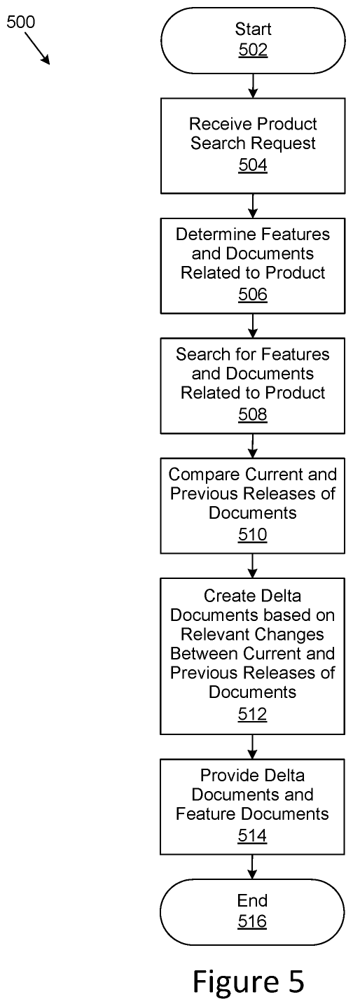

FIG. 5 is a generalized flowchart 500 for document management for products and/or services. The order in which the method is described is not intended to be construed as a limitation, and any number of the described method blocks may be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

The flowchart begins at step 502. At step 504, a search request is received as to a particular product. A business/company can provide the product or another outside business/company can provide the product. At step 506, a determination is made as to what are related features and documents to the product. As an example, features can include application programming interfaces (API). Documents can refer to files, data, or other information related to products. Documents can include videos and learning modules, release notes, installation guides, users' guides, multiple documents for the product, etc. At step 508, a search is performed for related features and documents to the product. The search can be done on local databases or storage. For features and documents that are not available on local databases or storage, the search can be performed using a web search on different environments, such as websites and platforms. At step 510, a comparison is made as to previous and current releases of the documents. At step 512, a delta document is created based on relevant changes in the comparison of previous and current releases of the document. In particular, identifying critical changes between two different versions of the same product is performed. At step 514, the delta documents and features are provided. The delta documents can include recommendation and configuration impact of the products on a user's implemented infrastructure. The recommendations can be based on compatibility factors related to particular infrastructures.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for document management for products comprising:
receiving a search request for a product;
determining related documents to the product;
searching for the related documents to the product;
performing comparison between previous and current versions of particular documents to the product;
creating a delta document based on the comparison between the previous and current versions of particular documents.

2. The method of claim 1, wherein the product is specific to a business or specific to another business.

3. The method of claim 1, wherein the searching for the related documents comprises searching company databases and searching external environments.

4. The method of claim 1, wherein the performing comparison comprises identifying upgrades and compatibility.

5. The method of claim 1, wherein the delta document includes providing recommendations based on compatibility factors, to users of the product.

6. The method of claim 1 further comprising determining related features to the product and providing documents related to the related features.

7. The method of claim 1 further comprising identifying critical changes between two different versions of the same product is performed.

8. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations for improved management of unattended user queries and comprising instructions executable by the processor and configured for:
performing a query search for a product;
determining related documents to the product based on the query search;
searching for the related documents to the product;
comparing current and previous versions of documents of the related documents;
providing a delta document that provides relevant changes between the current and previous versions of the documents.

8. The system of claim 8, wherein the performing a query search is directed to intent of a user and classification categories are returned based on the intent.

9. The system of claim 8, wherein the searching is performed on internal and external company resources and platforms.

10. The system of claim 8, wherein the product is one of other products managed by the system, wherein the products are provided by multiple companies.

11. The system of claim 8, wherein the delta document provides information as to changes to, upgrades to, and compatibility of the product to other products or configurations.

12. The system of claim 8, wherein the delta document provides suggestions to a user as to implementation of changes to the product.

13. The system of claim 8 further comprising determining related features to the product and providing documents associated with the related features.

14. A non-transitory, computer-readable storage medium embodying computer program code, the computer program code comprising computer executable instructions configured for:
performing a product specific search;
determining related documents to the product based on the product specific search;
searching for the related documents to the product;
comparing current and previous versions of documents of the related documents;
creating a delta document based on relevant changes between the current and previous versions of the documents.

15. The non-transitory, computer-readable storage medium of claim 14, wherein the performing the product specific search is initiated by a user of the product.

16. The non-transitory, computer-readable storage medium of claim 14, wherein the performing the product specific search is directed to user intent and classification categories are returned based on the user intent.

17. The non-transitory, computer-readable storage medium of claim 14, wherein the product is specific to a business or specific to another business.

18. The non-transitory, computer-readable storage medium of claim 14, wherein the delta document provides information as to changes to, upgrades to, and compatibility of the product to other products or configurations.

19. The non-transitory, computer-readable storage medium of claim 14, wherein the delta document comprises suggestions as to use and implementation of the product.

20. The non-transitory, computer-readable storage medium of claim 14 further comprising determining related features to the product and providing documents associated with the related features wherein the delta document comprises suggestions as to use and implementation of the product.
